(19) United States
(12) Patent Application Publication
(10) Pub. No.: US 2018/0347024 A1
(43) Pub. Date: Dec. 6, 2018

(54) METHOD FOR FORMING THERMAL SPRAYED COATING

(71) Applicant: TOYOTA JIDOSHA KABUSHIKI KAISHA, Toyota-shi (JP)

(72) Inventor: Kazuaki NISHIO, Nisshin-shi (JP)

(73) Assignee: TOYOTA JIDOSHA KABUSHIKI KAISHA, Toyota-shi (JP)

(21) Appl. No.: 15/994,700

(22) Filed: May 31, 2018

(30) Foreign Application Priority Data
Jun. 5, 2017 (JP) 2017-110881

(51) Int. Cl. C23C 4/10; C23C 4/134

(52) U.S. Cl. CPC C23C 4/10; F05C 2253/12; C23C 4/134

(57) ABSTRACT

In the plasma spraying according to the present embodiment, the zircon powders are excessively heated to raise the average temperature of the molten particles to a temperature range of 2820 to 4200° C. As a result, SiO2 in the zircon powders is vaporized, and the component ratio of ZrO2 in the molten particles is relatively increased. Such zircon powders land on the surface of the base material, and the deposit coagulates, the coagulum forms a thermal sprayed coating with a high composition ratio Zr/Si.

### CROSS-REFERENCE TO RELATED APPLICATION

The present disclosure claims priority under 35 U.S.C. § 119 to Japanese Patent Applications No. 2017-110881, filed on Jun. 5, 2017. The contents of these applications are incorporated herein by reference in their entirety

### TECHNICAL FIELD

The present application relates to a method for forming a thermal sprayed coating, and more particularly, to a method for forming a thermal sprayed coating on a constitution surface of a combustion chamber of an engine.

### BACKGROUND

A combustion chamber of an engine is generally defined by a space surrounded by a bore surface of a cylinder block, a top surface of a piston housed in the bore surface, and a bottom surface of a cylinder head, when the cylinder head is fitted to the cylinder block. A heat shielding coating may be formed on a constitution surface such as the bore surface, the top surface and the bottom surface in order to reduce a cooling loss of the engine and protect against heat generated by combustion.

JP2016-98407A discloses a cylinder head in which a thermal sprayed coating is formed on a bottom surface as a heat shielding coating. This thermal sprayed coating has a surface layer and an inner layer. The surface layer is composed of ZrO2-SiO2 based ceramics (zircon: ceramics whose main component is ZrSiO4). The inner layer is made of Ni alloyed material in which bentonite is dispersed.

ZrO2-SiO2 based ceramics of the surface layer is derived from natural mineral and has an advantage of being inexpensive. On the other hand, the thermal sprayed coating composed of this ceramics has a disadvantage that it is inferior in the thermal conductivity as compared with a general thermal sprayed coating composed of ZrO2-Y2O3 based ceramics. Specifically, the thermal sprayed coating composed of ZrO2-SiO2 based ceramics has higher thermal conductivity than thermal sprayed coating composed of ZrO2-Y2O3 based ceramics. In other words, the thermal sprayed coating composed of ZrO2-SiO2 based ceramics has lower heat shielding properties than the thermal sprayed coating composed of ZrO2-Y2O3 based ceramics.

In order to solve this problem, the present inventor tried to increase porosity of the thermal sprayed coating composed of ZrO2-SiO2 based ceramics. However, it was found that the increase in the porosity of this thermal sprayed coating develops another problem. First, the strength of the thermal sprayed coating decreases. Secondly, during finish machining of the surface of the thermal sprayed coating, a large number of internal pores are exposed on the surface and surface roughness becomes worsen. Thirdly, in order to increase the porosity of the thermal sprayed coating, it is necessary to form the coating while suppressing the melting of the ceramics powders. However, if the melting of the ceramics powders is suppressed, the yield of the coating decreases.

The present disclosure addresses to the problem mentioned above and an object of the present disclosure is to provide a method for forming a thermal sprayed coating composed of ZrO2-SiO2 based ceramics coating having a thermal conductivity small enough to be applicable to the constitution surface of the combustion chamber of the engine.

### SUMMARY

The present disclosure provides a method for forming a thermal sprayed coating.

The method includes a step of supplying thermal spraying powders to flame from a thermal spraying gun to spray and deposit on a constitution surface of a combustion chamber of an engine.

The thermal spraying powders are ceramics powders composed of ZrO2-SiO2 based ceramics.

In the supplying step, average temperature of the supplied ceramics powders is increased within a temperature range being higher than vaporization temperature of SiO2 which constitutes the ceramics powders and lower than vaporization temperature of ZrO2 which constitutes the ceramics powders.

A composition ratio Zr/Si of the deposit on the constitution surface is 1.5 or more.

In the method, the vaporization temperature of SiO2 is desirably around 2820° C. The temperature around 2820° C. means that a temperature error of plus or minus 10° C. may be included (i.e. from 2810° C. to 2830° C.).

In the method, the vaporization temperature of ZrO2 is desirably 4200° C.

According to the present disclosure, the average temperature of the supplied ceramics powders is increased within the above mentioned temperature range. In such a temperature range, SiO2 in the ceramics powders vaporizes while ZrO2 in the ceramics powders does not vaporize. Therefore, component ratio of SiO2 becomes relatively lower and the composition ratio Zr/Si in the deposit becomes 1.5 or more. And, through experimentations by the present inventor, it was confirmed that thermal conductivity of the deposit having composition ratio Zr/Si of 1.5 or more is sufficiently small. Therefore, according to the present disclosure, it is possible to obtain a thermal sprayed coating composed of ZrO2-SiO2 based ceramics, which has a thermal conductivity small enough to be applicable to the constitution surface of the combustion chamber of the engine.

### BRIEF DESCRIPTION OF DRAWINGS

FIG. 1 is a diagram for describing an example of a thermal spraying equipment used by a coating method according to an embodiment of the present disclosure;

FIG. 2 is a diagram for showing thermal equilibrium state of ZrO2-SiO2 alloy;

FIG. 3 is a diagram for describing state of zircon powders supplied to plasma flame in a conventional and normal plasma spraying;

FIG. 4 is a diagram for describing a problem of a thermal sprayed coating being composed of zircon and having large porosity;

FIG. 5 is a diagram for describing another problem of the thermal sprayed coating being composed of zircon and having large porosity;

FIG. 6 is a diagram for describing an example of an equipment used for temperature measurement of molten particles;

FIG. 7 is a diagram for describing an experimental result of temperature of zircon powders in plasma flame;

FIG. 8 is an example of a sectional image of a thermal sprayed coating;

FIG. 9 is an example of a SEM image of a thermal sprayed coating;

FIG. 10 is a diagram for showing an example of a result of elemental analysis by EDS;

FIG. 11 is a diagram for describing an experimental result of porosity of a thermal sprayed coating;

FIG. 12 is a diagram for describing an experimental result of composition ratio Zr/Si in a thermal sprayed coating;

FIG. 13 is a diagram for describing an experimental result of thermal conductivity of a thermal sprayed firm; and

FIG. 14 is a diagram for describing state of zircon powders supplied to plasma flame in a plasma spraying according to the embodiment of the present disclosure.

### DETAILED DESCRIPTION

An embodiments of the present application is described below with reference to the accompanying drawings. Elements common to each drawing are assigned the same reference number or symbol, and redundant description of the common elements is omitted. In addition, the following embodiments do not limit the present application.

### [Outline of a Coating Method]

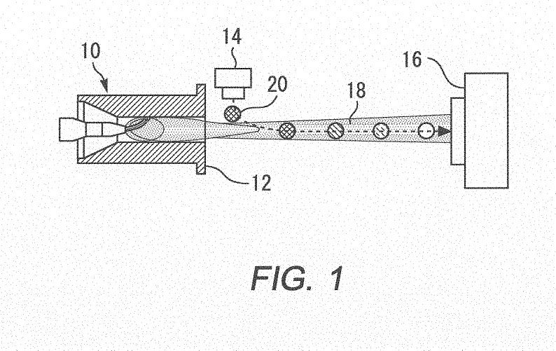

A firm formation method according to the embodiment of the present disclosure is applied to form a thermal sprayed coating on a constitution surface of a combustion chamber of an engine (hereinafter referred to as a “chamber wall”). First, the coating method according to the embodiment will be described with reference to FIG. 1. FIG. 1 is a diagram for describing an example of a thermal spraying equipment used by the coating method. A thermal spraying equipment 10 shown in FIG. 1 includes a thermal spraying gun 12 and a powder injector 14. The thermal spraying gun 12 is configured to inject plasma flame 18 toward a surface of a base material (an engine part) 16. The powder injector 14 is configured to supply thermal spraying powders 20 into the plasma flame 18. The thermal spraying powders 20 are ceramics powders of ZrO2-SiO2 based ceramics (Specifically, ceramics powders containing ZrO4 and 33 weight % of SiO2. Hereinafter referred to the powders as “zircon”.)

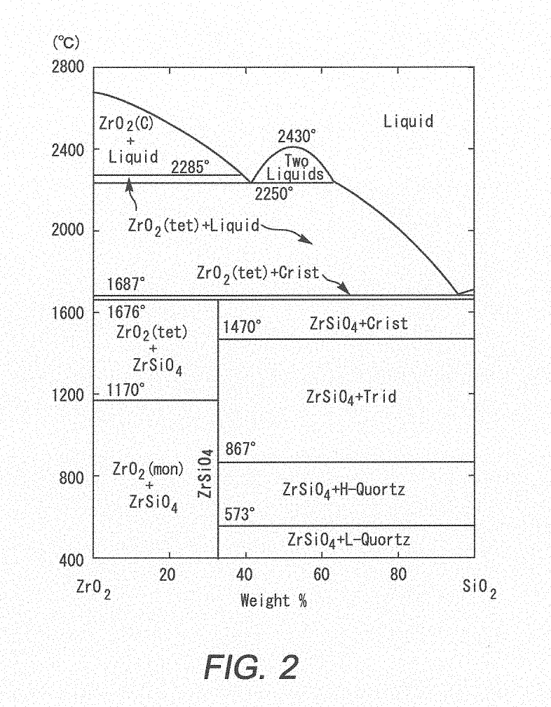

Zircon is known as an inexpensive thermal spraying material derived from natural mineral. FIG. 2 is a diagram for showing thermal equilibrium state of ZrO2-SiO2 alloy. The horizontal axis of FIG. 2 represents weight % of SiO2 in ZrO2-SiO2 alloy. Zircon is classified to ceramics, however, it is strictly different from ZrO2-SiO2 alloy. The thermal equilibrium state of zircon is explained based on a line segment at a horizontal axis of 33 weight %. Specifically, when zircon is in a temperature range of 400 to 1676° C., it is in a solid phase of ZrSiO4. In a temperature range from 1676 to 1687° C., zircon separates into tetragonal of ZrO2 (tet) and cristobalite phase of SiO2 (Crist). In a temperature range of 1687 to 2400° C., zircon is in coexistence state of tetragonal of ZrO2 (tet) and liquid phase of SiO2 (Liquid). In a temperature range from 2400 to 2800° C., zircon is a liquid phase of ZrO2 and SiO2 (Liquid).

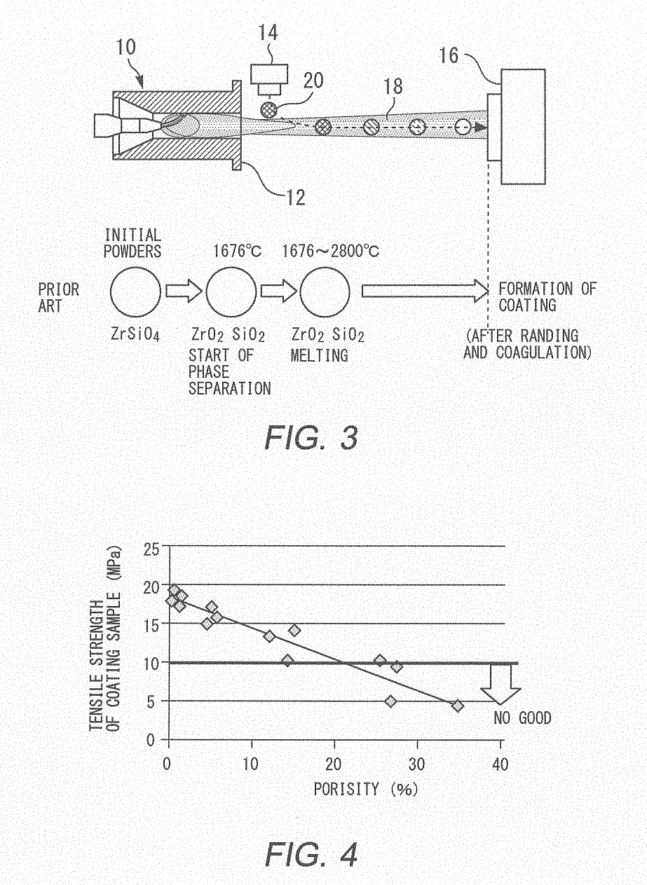

FIG. 3 is a diagram for describing state of zircon powders supplied to plasma flame in a conventional and normal plasma spraying. The state of zircon powders is explained based on the thermal equilibrium state of zircon of FIG. 2. The zircon powders before being supplied to the plasma flame (i.e. initial powders) are composed of ZrSiO4. When the zircon powders are supplied to the plasma flame and their temperature increase to 1670° C., ZrSiO4 is separated to ZrO2 and SiO2. When the temperature of the zircon powders increase to the temperature range from 1676 to 2800° C., both ZrO2 and SiO2 melt.

In other words, in the normal plasma spraying, it is considered that the zircon powders supplied to the plasma flame are melted in a state including ZrO2 and SiO2 separated from ZrSiO4, and ZrSiO4. When the zircon powders in such a state land on the surface of the base material 16, these powders deposit thereon. And when the deposit coagulates, the coagulum forms a thermal sprayed coating. Since a surface of the coagulum is rough, the surface is generally smoothed by a finish machining (a polishing process).

### [Problems in the Conventional Thermal Spraying]

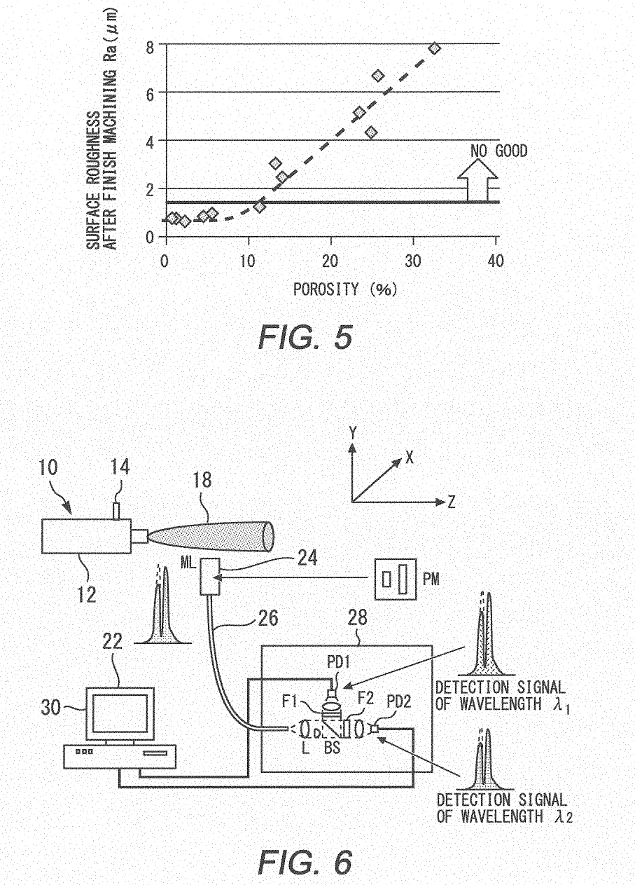

As mentioned above, there is a problem that the thermal sprayed coating composed of zircon has lower heat shielding properties than the thermal sprayed coating composed of ZrO2-Y2O3 based ceramics. However, another problem is developed when the porosity of the thermal sprayed coating is increased for the purposed of improving the heat shielding properties. FIG. 4 and FIG. 5 are diagrams for describing the problem of the thermal sprayed coating being composed of zircon and having large porosity. FIG. 4 shows measurement result of tensile strength of a coating sample. FIG. 5 shows measurement result of surface roughness Ra of the coating sample after the finish machining. The measurements in FIG. 4 to FIG. 5 were carried out with a coating sample having a general porosity less than 15% and a coating sample having a large porosity from 30 to 80%.

As shown in FIG. 4, when the porosity of the coating sample increases, the tensile strength decreases. From this result, it can be seen that a problem will be developed from a reliability perspective when the thermal sprayed coating having a large porosity is applied to the chamber wall. In addition, as shown in FIG. 5, when the porosity of the coating sample exceeds 10%, the surface roughness Ra of the coating sample after the finish machining increases as the porosity increases. This is because that a large number of internal pores are exposed during the finish machining. When the surface roughness Ra increases, the surface area of the coating sample (i.e. an area from which heat can transfer to inside of the coating sample) enlarges, so the heat shielding properties decrease rather than increase. Therefore, it can be seen that there will be another problem developed from heat shielding properties when the thermal sprayed coating having a large porosity is applied to the chamber wall.

### [Experimentation Based on the Conventional Thermal Spraying]

### 1. Measurement of Temperature of the Zircon Powders (Hereinafter Referred to as “Molten Particles”) in the Plasma Flame

In consideration of the problems mentioned above, the present inventors experimented how the temperature of the molten particles change depending on heat amount input to the zircon powders. In this specification, the heat input amount means ratio of output (kW) of the plasma to flow rate (l/min) of working gas. When the flow rate of the working gas increases, the speed of plasma flame increases. As the power of the plasma increases, the temperature of the plasma flame increases. For example, under the condition that the plasma output is high and the flow rate of the working gas is low, the plasma flame whose speed is low and temperature is high exchanges heat with the zircon powders. That is, in this case, the heat input amount is large.

The temperature of molten particles was measured under the following conditions.

Thermal spraying gun: SinplexPro or TriplexPro, diameter φ of the gun nozzle is 9 mm, manufactured by Oerlikon Metoco, Inc

Sample powders: ZrSiO4, average particle diameter of 27 μm, particle size distribution of 10 to 45 μm, manufactured by Minoganryo Corp.

Measurement equipment: DPV eVOLUTION, manufactured by Tecnar

Measurement point: a position 100 mm from the tip of the gun nozzle (spraying distance)

Input conditions: conditions are set where efficiency of the coating (coating thickness) becomes the maximum. Specifically, conditions are set by fixing powder feeding distance of 12 mm and powder injector inner diameter of 2.0 mm while adjusting flow rate of the carrier gas (Ar)

FIG. 6 is a diagram for describing an example of an equipment used for measuring the temperature of the molten particles. The measurement equipment 22 shown in FIG. 6 includes a measurement head 24, an optical fiber 26, a detection unit 28, and a measurement PC 30. The measuring head 24 includes an enlarging lens ML and a photomask PM having two slits. The detection unit 28 includes a lens L, a beam splitter BS, two spectral filters F1 and F2, and two photodetectors PD1 and PD2.

The measurement head 24 sends light (self-emission) of the molten particles crossing a focal position of the magnifying lens ML to the detection unit 28 via the photomask PM and the optical fiber 26. The detection unit 28 passes the transmitted light through the lens L to convert it into a parallel light ray. The detection unit 28 divides the parallel light into light of wavelength λ1 of 900 nm or more and light of wavelength λ2 of 900 nm or less by the beam splitter BS. The photodetectors PD1 and PD2 detect the light amounts of the wavelengths λ1 and λ2 that have passed through the spectral filters F1 and F2. The measurement PC 30 measures the temperature T(k) of the molten particles at time k from the intensity ratio (area ratio R=A1/A2) of the signals of the light amounts of the wavelengths λ1 and λ2, using the principle of the two-color radiation thermometer.

Temperature T(k) of the molten particles was calculated based on equation (1). Note that K2 in the equation (1) is a radiation second constant.

$$\begin{matrix}T ( k ) = \frac{{K}_{2} ( {λ}_{1} - {λ}_{2} )}{{λ}_{1} \cdot {λ}_{2}} [ \frac{1}{ln R + 5 ln ( \frac{{λ}_{1}}{{λ}_{2}} )} ] & ( 1 ) \\ R = \frac{E ( {λ}_{1} )}{E ( {λ}_{2} )} = \frac{{A}_{1}}{{A}_{2}} & ( 2 )\end{matrix}$$

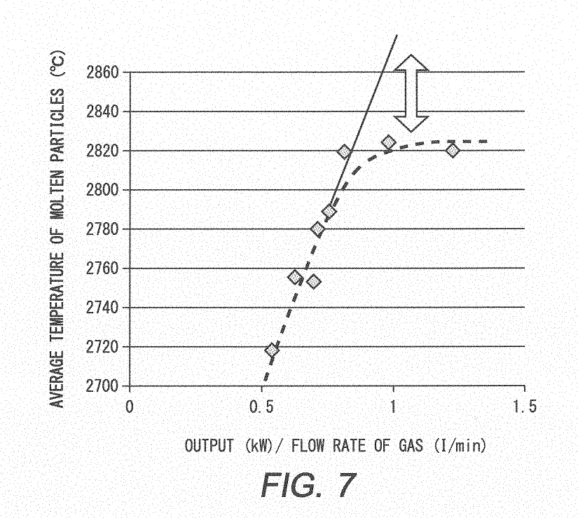

FIG. 7 is a diagram for describing an experimental result of temperature of zircon powders in plasma flame. As shown in FIG. 7, average temperature of the molten particles increases in proportion to the heat input amount. However, this proportional relationship is established up to a certain heat input amount. That is, the average temperature of the molten particles does not rise at a certain heat input amount (specifically, 0.8), and it is kept at a constant temperature (specifically, around 2820° C.).

### 2. Measurement of Composition and Porosity of the Thermal Sprayed Coating

Based on the results in FIG. 7, the present inventors experimented how the composition and porosity of the thermal sprayed coating change depending on the heat input amount. A thermal sprayed coating for the experimentation was prepared under the following conditions.

Thermal spraying gun: SinplexPro or TriplexPro, diameter φ of the gun nozzle is 9 mm, manufactured by Oerlikon Metoco, Inc

Sample powders: ZrSiO4, average particle diameter of 27 μm, particle size distribution of 10 to 45 μm, manufactured by Minoganryo Corp.

Supply amount of powders: 30 g/min from one injection port

Spraying distance: a position 100 mm from the tip of the gun nozzle

Input conditions: conditions are set where efficiency of the coating (coating thickness) becomes the maximum. Specifically, conditions are set by fixing powder feeding distance of 6 mm and powder injector inner diameter of 2.0 mm while adjusting flow rate of the carrier gas (Ar)

Sample shape: The thermal sprayed coating having a thickness of 700 to 1000 μm formed under the above conditions is processed to φ of 6 mm (without base material)

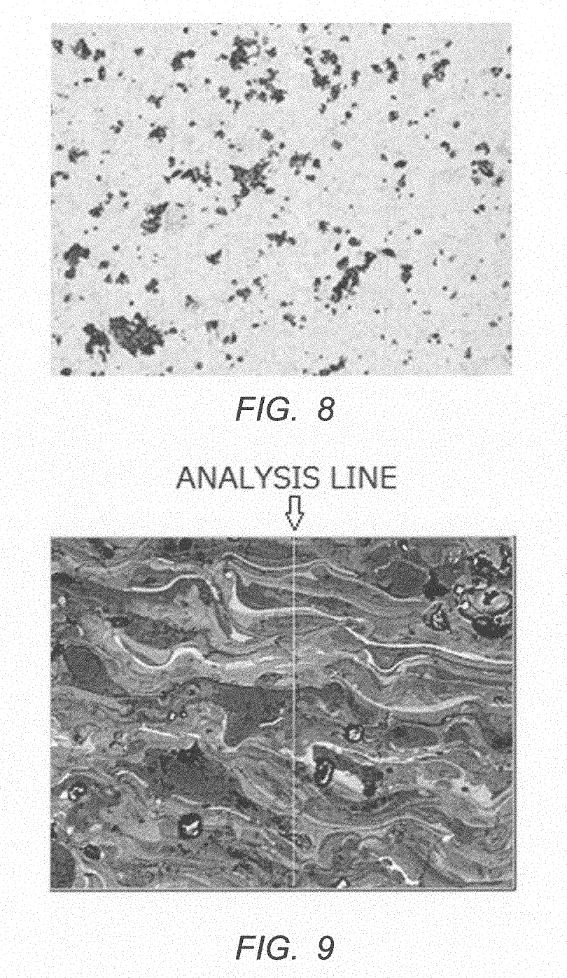

The porosity of the thermal sprayed coating was measured as follows. First, a section of the thermal sprayed coating was photographed at 400 times using a laser microscope (VK-X 100 manufactured by KEYENCE). In addition, image trim was carried out when a field other than thermal sprayed coating was included. FIG. 8 is an example of a sectional image of the thermal sprayed coating. The black parts in the image correspond to the pores. Subsequently, binary conversion was performed by setting a threshold (upper limit of 65000 and lower limit of 28000) using analysis application (VK-X Series). Then, porosity was calculated from the binary pore area and the whole thermal sprayed coating area.

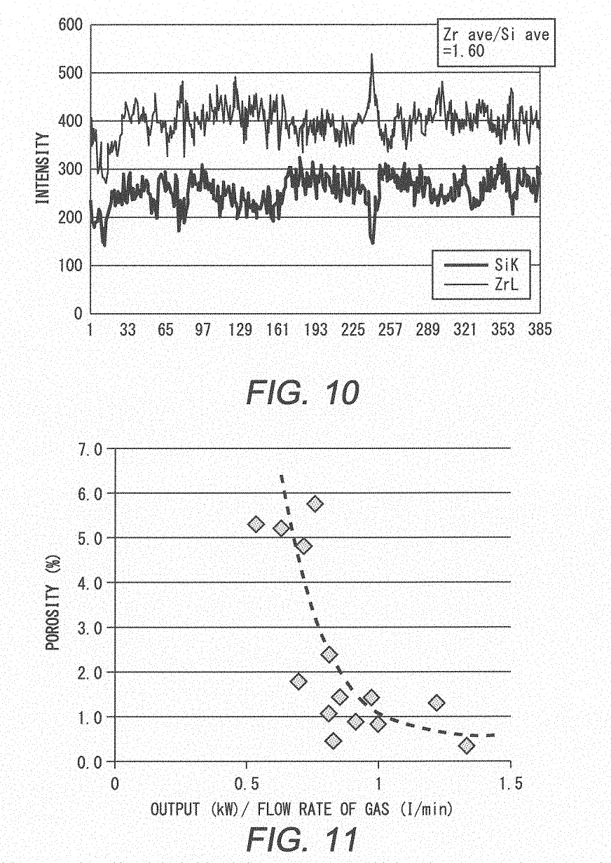

The composition of the thermal sprayed coating was measured as follows. First, SEM image (backscattered electron image) of a cross section of the thermal sprayed coating was magnified 1000 times. Next, from the enlarged image, a section without unmolten particles and cracks was selected, and X rays generated from the analysis line in the thickness direction were taken in by the EDS detector and elemental analysis was carried out. The elements to be analyzed were Zr and Si. FIG. 9 is an example of a SEM image of the thermal sprayed coating. FIG. 10 is a diagram for showing an example of a result of elemental analysis by EDS. In FIG. 10, the horizontal axis represents number of data points, and the vertical axis represents average intensity of each element. As shown in FIG. 10, the average intensity of Zr is distributed in a range of approximately 300 to 500, and the average intensity of Si is distributed in approximately 200 to 300.

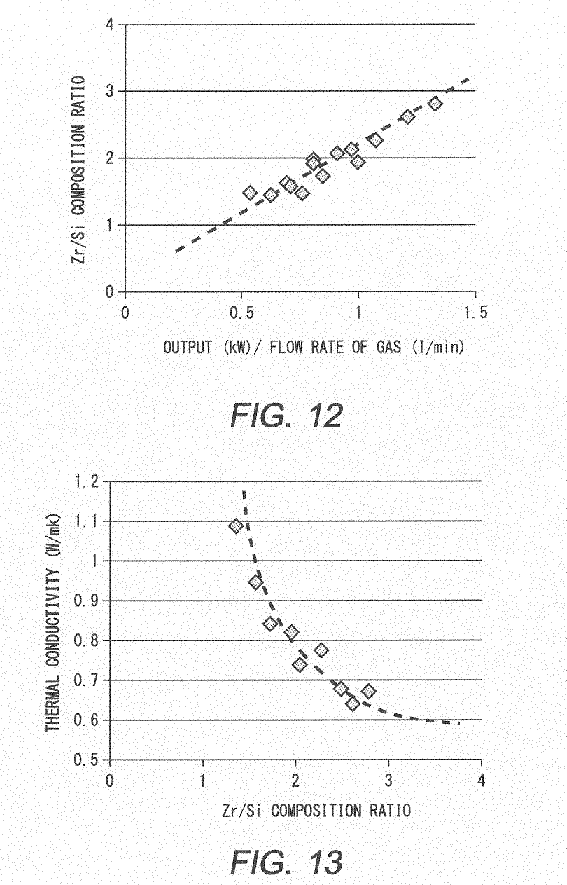

FIG. 11 is a diagram for describing an experimental result of porosity of the thermal sprayed coating. As shown in FIG. 11, as the heat input increases, the porosity of the thermal sprayed coating decreases. FIG. 12 is a diagram for describing an experimental result of composition ratio Zr/Si in the thermal sprayed coating. The composition ratio Zr/Si on the vertical axis of FIG. 12 is a ratio of the average intensities of Zr and Si shown in FIG. 10. As shown in FIG. 12, when the heat input amount increases, the composition ratio Zr/Si increases. From the experimentation results of FIG. 11 and FIG. 12, it can be seen that as the heat input amount is increased, the porosity of the thermal sprayed coating becomes smaller and the composition ratio Zr/Si becomes higher. On the contrary, when the heat input amount is decreased, the porosity of the thermal sprayed coating increases and the composition ratio Zr/Si decreases.

As mentioned in FIG. 12, the composition ratio Zr/Si becomes higher when the input heat amount is increased. In the other words, the component ratio of Zr in the thermal sprayed coating increases relatively while that of Si decreases relatively. Here, as described in FIG. 7, the average temperature of the molten particles is constant at a temperature around 2820° C. from the certain heat input temperature. Regarding the temperature, the upper limit of the vertical axis (see FIG. 2) of the thermal equilibrium state diagram is 2800° C. Therefore, although the phase state when the temperature of the zircon powders is around 2820° C. is unknown from FIG. 2, in consideration of the state of zircon powders described in FIG. 3 (i.e. both ZrO2 and SiO2 in the zircon powders melt at 2800° C.) and the experimentation result shown in FIG. 12, the reason why the experimentation result of FIG. 7 was obtained is estimated by the present inventors as follows. That is, the present inventors estimate that vaporization of SiO2 causes to keep the average temperature at the temperature around 2820° C.

Based on the estimation, the present inventors experimented how the thermal conductivity of the thermal sprayed coating varies depending on the heat input amount. The thermal sprayed coating for the experiment was prepared under the following conditions.

Thermal spraying gun: SinplexPro or TriplexPro, diameter φ of the gun nozzle is 9 mm, manufactured by Oerlikon Metoco, Inc

Sample powders: ZrSiO4, average particle diameter of 27 μm, particle size distribution of 10 to 45 μm, manufactured by Minoganryo Corp.

Supply amount of powders: 30 g/min from one injection port

Spraying distance: a position 100 mm from the tip of the gun nozzle

Input conditions: conditions are set where efficiency of the coating (coating thickness) becomes the maximum. Specifically, conditions are set by fixing powder feeding distance of 6 mm and powder injector inner diameter of 2.0 mm while adjusting flow rate of the carrier gas (Ar)

Sample shape: The thermal sprayed coating having a thickness of 700 to 1000 μm formed under the above conditions is processed to φ of 6 mm (without base material)

The thermal conductivity λ of the thermal sprayed coating was calculated based on the following equation (3). In the equation (3), Cp is the specific heat capacity, ρ is the density, and α is the thermal diffusivity.

λ=Cₚ·ρ·α (3)

The specific heat capacity Cp was measured under the following conditions.

Measurement method: DSC method

Measuring device: DSC 8000 manufactured by Perkin Elmer Co.

Measurement sample: φ of 6 mm

Reference sample: sapphire (112.4 mg)

Measurement temperature: 25° C.

Rate of temperature increase: 20° C./min

Measurement atmosphere: N2 atmosphere

The thermal diffusivity a was measured and analyzed under the following conditions.

Measurement method: Flash method

Measuring device: LFA 467 manufactured by NETZSCH

Temperature measurement method: non-contact temperature measurement by sensor

Surface treatment: blackening agent coating (both sides)

Measurement temperature: room temperature

Measurement atmosphere: N2 atmosphere

Analysis method: Analysis including pulse width correction and heat loss correction

FIG. 13 is a diagram for describing an experimental result of thermal conductivity of the thermal sprayed firm. In FIG. 13, the horizontal axis represents the composition ratio Zr/Si described in FIG. 12, and the vertical axis represents the thermal conductivity. As shown in FIG. 13, as the composition ratio Zr/Si increases, the thermal conductivity of the thermal sprayed coating decreases. When the experimentation result in FIG. 12 (i.e. the composition ratio Zr/Si increases as the heat input amount increases) is used to help understanding FIG. 13, it is understood that the experimentation result in FIG. 13 indicates that as the heat input amount increases, the thermal conductivity of the thermal sprayed coating decreases. And this indication is consistent with the experimentation result in FIG. 11.

As the porosity of the thermal sprayed coating decreases, the thermal conductivity of the thermal sprayed coating generally increases. However, the experimentation result in FIG. 13 is different from such a general tendency. The present inventors estimate the reason why the examination result of FIG. 13 was obtained as follows. That is, the present inventors estimate that the component ratio of ZrO2 increases relatively with vaporization of SiO2 in the molten particles, thereby the thermal conductivity is reduced despite the decrease in the porosity.

### [Characteristic of the Coating Method of the Present Disclosure]

Based on the above experimentations, the coating method according to the present embodiment adjust the heat input amount to keep the average temperature of the molten particles in a temperature range being higher than the temperature at which SiO2 constituting the zircon powders vaporizes and also lower than the temperature at which ZrO2 constituting the zircon powders does not vaporize. The temperature at which SiO2 constituting the zircon powders vaporizes corresponds to temperature around 2820° C. as described in FIG. 7. The temperature around 2820° C. means that a temperature error of plus or minus 10° C. may be included. The temperature at which ZrO2 constituting the zircon powders vaporizes corresponds to the boiling point of ZrO2 (i.e. 4200° C.).

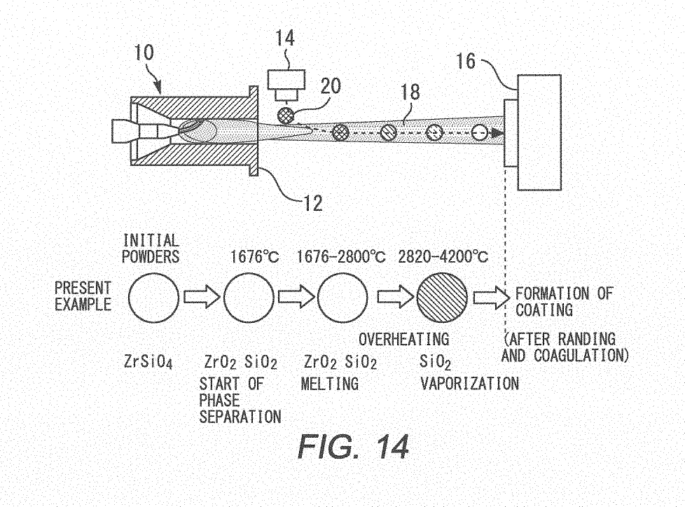

FIG. 14 is a diagram for describing state of zircon powders supplied to plasma flame in the plasma spraying according to the embodiment of the present disclosure. As shown in FIG. 14, the zircon powders (initial powders) before being put into the plasma flame are constituted by ZrSiO4. When the initial powders are put into the plasma flame and their temperature rise to 1676° C., ZrSiO4 is separated to ZrO2 and SiO2. Furthermore, when the temperature of the zircon powders rise to a temperature range of 1676 to 2800° C., both ZrO2 and SiO2 melt. Up to this point, it is the same as the normal plasma spraying (see the description of FIG. 3).

In the plasma spraying according to the present embodiment, the zircon powders are excessively heated to raise the average temperature of the molten particles to a temperature range of 2820 to 4200° C. As a result, SiO2 in the zircon powders is vaporized, and the component ratio of ZrO2 in the molten particles is relatively increased. Such zircon powders land on the surface of the base material 16, and the deposit coagulates, the coagulum forms a thermal sprayed coating with a high composition ratio Zr/Si.

From the experimentation result shown in FIG. 7, it can be seen that in order to raise the average temperature of the molten particles to a temperature around 2820° C., it is sufficient to set the heat input amount to 0.8 or more. Note that FIG. 7 does not show data in which the average temperature of the molten particles is raised to a temperature higher than the temperature around 2820° C. However, as already explained, the temperature of the plasma flame can be increased according to the output of the plasma. Therefore, by increasing the output of the plasma, it is possible to raise the average temperature of the molten particles to the temperature higher than the temperature around 2820° C.

In FIG. 7, it is predicted why the average temperature of the molten particles stays around 2820° C. regardless of the increase in the heat input amount is that only a portion of SiO2 constituting the zircon powders is vaporized. In other words, when all of the SiO2 constituting the zircon powders are vaporized, it is predicted that the average temperature of the molten particles will rise to the temperature higher than around 2820° C. Therefore, if the power of the plasma is increased, it is possible to raise the average temperature of molten particles to 4200° C.

However, when the average temperature of the molten particles rises to a temperature higher than 4200° C., ZrO2 consisting of the zircon powder is expected to start to vaporize. Therefore, it is possible to obtain a thermal sprayed coating having a high composition ratio Zr/Si when an upper limit temperature (i.e. 4200° C.) is set in spite of increasing the average temperature of the molten particles to any extent.

Further, in the coating method according to the present embodiment, the heat input amount is adjusted not only in the above temperature range but also in the thermal conductivity of the thermal sprayed coating. That is, the thermal conductivity of the thermal sprayed coating applied to the chamber wall is desirably 1.0 W/mK or less, more preferably 0.8 W/mK or less. Here, it is understood from the experimentation result shown in FIG. 13 that the thermal sprayed coating having the thermal conductivity of 1.0 W/mK or less has the composition ratio Zr/Si of 1.5 or more. It can be seen that the thermal sprayed coating having the thermal conductivity of 0.8 W/mK or less has the composition ration Zr/Si of 2.0 or more. Further, from the experimentation result shown in FIG. 12, it can be seen that the thermal sprayed coating having the composition ratio Zr/Si of 1.5 or more is formed by adjusting the heat input amount to 0.5 or more. Further, it is understood that the thermal sprayed coating having the composition ratio Zr/Si of 2.0 or more is formed by adjusting the heat input amount to 1.0 or more.

From a viewpoint of forming a thermal sprayed coating having a low thermal conductivity, it is also possible to set a lower limit of the heat input amount to 0.5 or less. However, as can be seen from the experimentation result shown in FIG. 7, if the heat input amount is set lower than 0.8, the average temperature of molten particles does not rise to 2820° C. Therefore, the vaporization of SiO2 may be insufficient. Therefore, in the coating method according to the present embodiment, the lower limit of the heat input amount is set to 0.8. By setting the lower limit of the heat input to 0.8, the average temperature of the molten particles is raised to a temperature higher than 2820° C. Consequently, the thermal sprayed coating having the composition ratio Zr/Si is 1.5 or more and the thermal conductivity is 1.0 or less is obtained.

What is claimed is:

1. A method for forming a thermal sprayed coating comprising a step of supplying thermal spraying powders to flame from a thermal spraying gun to spray and deposit on a constitution surface of a combustion chamber of an engine, wherein:
the thermal spraying powders are ceramics powders composed of ZrO2-SiO2 based ceramics;
in the step for supplying the thermal spraying powders, average temperature of the supplied ceramics powders is increased within a temperature range being higher than vaporization temperature of SiO2 which constitutes the ceramics powders and lower than vaporization temperature of ZrO2 which constitutes the ceramics powders; and
a composition ratio Zr/Si of the deposit on the constitution surface is 1.5 or more.

2. The method according to the claim 1, wherein the vaporization temperature of SiO2 is around 2820° C.

3. The method according to the claim 1, wherein the vaporization temperature of ZrO2 is 4200° C.
